(19) United States
(12) Patent Application Publication
(10) Pub. No.: US 2008/0200188 A1
(43) Pub. Date: Aug. 21, 2008

(54) Base-Station-Controlled Paging in Mobile Radio Systems

(76) Inventors: Jarno Rajahalme, Kirkkonummi (FI); Timo M. Rantalainen, Helsinki (FI); Sami Uskela, Helsinki (FI); Seppo Vesterinen, Oulunsalo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/885,905

(22) PCT Filed: Mar. 9, 2005
(86) PCT No.: PCT/IB2005/000588

§ 371 Date: Sep. 7, 2007

(51) Int. Cl. H04Q 7/20

(52) U.S. Cl. 455/458

(57) ABSTRACT

This invention relates to a method for paging a mobile station (6-1 . . . 6-3) in a mobile radio system (1a; 1b) that comprises a plurality of base stations (3a-1, 3a-2; 3b-1, 3b-2; 3-1 . . . 3-3) each serving at least one cell (80-1 . . . 80-3) of said mobile radio system, said method comprising receiving (100) a data packet destined for said mobile station at one of said base stations during a dormant period of said mobile station, wherein it is unknown in which cell of said mobile radio system said mobile station is located during said dormant period; and taking action (103, 105) at said base station that received said data packet to page said mobile station in response to said received data packet in order to determine said cell in which said mobile station is located. The invention further relates to a corresponding computer program, computer program product, base station, mobile radio system and mobile station.

### CROSS-REFERENCE TO RELATED APPLICATION

This application is the U.S. National Stage of International Application Number PCT/IB2005/000588 filed Mar. 9, 2005 and published in English Sep. 14, 2006 under International Publication Number WO2006/095213 A1.

### FIELD OF THE INVENTION

This invention relates to a method for paging a mobile station in a mobile radio system that comprises a plurality of base stations each serving at least one cell of said mobile radio system. The invention further relates to a corresponding computer program, computer program product, base station, mobile station and mobile radio system.

### BACKGROUND OF THE INVENTION

Mobile radio systems as for instance the Universal Mobile Telecommunications System (UMTS) comprise a Core Network (CN), a Radio Network (RAN) and a plurality of mobile stations (also denoted as “User Equipment” in UMTS terminology).

Therein, the CN is responsible for switching and routing calls and data connections to external networks, which can be either packet-switched, like for instance the Internet, or circuit-switched, like for instance the Integrated Services Digital Network (ISDN) or the Public Switched Telephone Network (PSTN).

The RAN consists of one or more Radio Network Sub-systems (RNS), which consist of one base station controller (denoted as “Radio Network Controller (RNC)” in UMTS terminology) and one or more base stations (denoted as “Node B” in UMTS terminology). The base stations may be understood as radio transceivers that are distributed across the area that is to be covered by the mobile radio system and interface with the mobile stations via a radio interface. Each base station serves one or more cells, i.e. provides radio coverage for the mobile stations that are located in said one or more cells. An example of a base station serving one cell is a base station with a substantially omnidirectional antenna characteristic, which provides radio coverage for a substantially circular area that is usually approximated by a hexagonal area. In contrast, an example of a base station that serves more than one cell is a base station that uses sectorized antennas, wherein the radio coverage area of each of said sectorized antennas, which area is often denoted as a sector, then may be understood as a cell. To reduce inter-cell interference, different orthogonal or pseudo-orthogonal transmission resources, like for instance frequencies or scrambling codes, may be used in cells that are served by the same base station. The base station then usually is capable of differentiating between the cells it serves. Equally well, the same transmission resources may be used in all cells that are served by a base station. The base station controller owns and controls the radio resources in its domain, i.e. the base stations connected to it. The base station controller is the service access point for all services the RAN provides to the CN, for example management of connections to the mobile station.

Finally, the mobile stations act as an interface between the user and the mobile radio system.

Mobile radio systems usually support dormant periods (also denoted as idle or power-saving periods) of their mobile stations during which said mobile stations are in a dormant mode, i.e. the mobile stations restrict their ability to receive data packets on traffic channels by reducing monitoring of these traffic channels. This allows the mobile station to save power and reduces signaling required in the mobile radio system. During a dormant period, special steps need to be taken by the RAN to locate the mobile station and alert it. These steps differ depending on the radio link, but the generic name for this process is paging.

Paging is at least partially based on the introduction of routing areas in the mobile radio system, wherein a routing area may be formed by the cells served by a group of neighboring base stations. The coverage area of the mobile radio system then can be imagined to be paved with a substantially seamless grid of routing areas, wherein each routing area comprises a plurality of cells. The RAN keeps track of the position of each mobile station at a routing-area level (not at the more precise cell level) during dormant periods of said mobile station. This is achieved by demanding that, even during dormant periods, the mobile station has to listen for beacon messages that are transmitted by the base stations and that contain an identification of the one or more routing areas the respective base station is associated with. When a mobile station recognizes that it moves from one routing area to another routing area during said dormant period, it has to signal this change to the RAN. The routing area of each mobile station is then registered, for instance within the RAN.

If paging of a mobile station is required during a dormant period of said mobile station, usually the base station controller sends paging messages to all base stations of the routing area in which said mobile station is (or is assumed to be) located. Upon reception of such a paging message, which contains an identifier of the mobile station that is to be paged, each base station broadcasts a paging message for said mobile station in the one or more cells it serves. Upon reception of the paging message, the mobile station the paging message is destined for responds to the base station from which it received the paging message, allowing for an identification of the cell said mobile station is located in. In case of more than one cell being served by said base station, the cell said mobile station is located in may for instance be differentiated from the other cells served by said base station by the carrier frequency. Then for instance a traffic channel between the mobile station and the base station can be established.

To reduce the amount of signaling required in the RAN during the paging of a mobile station, prior art document US 2004/0203934 A1 proposes to register the base stations of a routing area in a multicast group and to send a single multicast paging message from the base station controller to this multicast group instead of separately sending a plurality of paging messages to the base stations of the routing area, respectively.

Prior art so far sets out from paging functionality to be implemented in the base station controller, wherein this functionality controls and triggers the sending of paging messages to the base stations of a routing area. However, the implementation of such functionality increases the complexity and costs of the base station controller and furthermore restricts the flexibility in changing the architecture of the RAN.

### SUMMARY OF THE INVENTION

In view of the above-mentioned problems, it is, inter alia, an object of the present invention to provide an improved method, computer program, computer program product, base station, mobile station and mobile radio system to be used in the context of paging of mobile stations in a mobile radio system.

It is proposed a method for paging a mobile station in a mobile radio system that comprises a plurality of base stations each serving at least one cell of said mobile radio system, said method comprising receiving a data packet destined for said mobile station at one of said base stations during a dormant period of said mobile station, wherein it is unknown in which cell of said mobile radio system said mobile station is located during said dormant period; and taking action at said base station that received said data packet to page said mobile station in response to said received data packet in order to determine said cell in which said mobile station is located.

Said mobile radio system may be any wireless data transmission system such as for instance a mobile communications system, a wireless local area network or a paging system. Said mobile radio system comprises a plurality of base stations that are distributed across the coverage area of said mobile radio system, serve a plurality of cells of said mobile radio and provide an interface for wireless data transfer for the mobile stations that are located in the cells served by said base stations. Accordingly, said mobile stations may for instance be mobile phones, personal digital assistants, lap-top computers, pagers or any other type of radio devices.

At said base station, a data packet destined for said mobile station is received during a dormant period of said mobile station. Therein, said data packet may be understood to require the establishment of a specific traffic channel between said mobile station and a base station of said mobile radio system that may not be established during said dormant period. Said data packet particularly does not represent a paging message. Said data packet may represent data from a circuit-switched connection or a packet-switched connection. During said dormant period, it is unknown in which cell of said mobile radio system said mobile station is located, for instance because said mobile station, when moving from one cell of said mobile radio system to another cell of said mobile radio system, does not necessarily signal the change of the cell to said mobile radio system.

In order to deliver said data packet to said mobile station, it may thus first be required to page said mobile station, wherein said paging comprises locating said mobile station at cell precision (i.e. with the accuracy of a cell) and alerting said mobile station. After said locating and alerting of said mobile station, then a traffic channel between said mobile station and the base station serving the cell in which said mobile station is located may be established to allow for a transmission of said data packet to said mobile station.

According to the present invention, it is possible to directly send a data packet destined for a mobile station that is in dormant mode to a base station of said mobile radio system. Said data packet may for instance be directly sent from a core network of said mobile radio system to said base station because said base station serves as a temporary anchoring point for the paging of said mobile station. This may for instance be due to the fact that the last data transfer of said mobile station was serviced by said base station, or because said mobile station last registered with said-base station, for instance before entering a dormant mode or because of a change of a routing area by said mobile station, or for any other reason.

In response to said received data packet, said base station then notices that paging of said mobile station is required before said data packet can be delivered and accordingly takes action to page said mobile station. This may for instance be achieved by sending at least one paging message to a group of base stations that are associated with a routing area of said mobile radio system, in order to trigger the broadcasting of respective paging messages for said mobile station by said base stations of said group of base stations.

In contrast to prior art, where some type of base station controller (for instance an RNC in a UMTS system) notices that, due to incoming data packets destined for a mobile station that is currently in a dormant mode, a paging of said mobile station is required and then takes action to page said mobile station (by sending one or more paging messages to a group of base stations, which are associated with a routing area in which said mobile station is assumed to be located, in order to trigger said base stations to broadcast paging messages for said mobile station in their respective cells), the present invention proposes that said base station implements this functionality of the base station controller. Thus all paging functionality of the mobile radio system may be distributed into the base stations of said mobile radio system instead of having a centralized paging controller. The base station controller that implements such a centralized paging controller then may no longer be required for the mobile radio system architecture, at least with respect to its paging functionality. Said base station may then for instance directly receive data packets destined for mobile stations, regardless whether in dormant period or not, from a core network of said mobile radio system, for instance from an MSC and/or SGSN in case of a mobile communications system with a core network according to the UMTS standard or a successor thereof.

The present invention thus may for instance be either exploited to simplify base station controllers in existing mobile radio systems, or to completely dispense with base station controllers in future architectures of mobile radio systems.

According to an embodiment of the present invention, said plurality of base stations comprises one or more groups of base stations, each of said groups of base stations is associated with a respective routing area in a way that said cells served by said base stations of a group of base stations form said respective routing area, and said paging of said mobile station comprises sending respective paging messages for said mobile station from each of said base stations of at least one of said one or more groups of base stations.

The coverage area of said mobile radio system then may for instance be divided into a plurality of routing areas, and each of these routing areas may consist of a plurality of cells that are served by the base stations of a respective group of base stations. The base stations associated with a routing area then all send paging messages for said mobile station in their respective cells, and upon reception of such a paging message, said mobile station may notice that it is paged by the mobile radio system and may respond to the base station from which it received the paging message. Said base stations may for instance send said paging message for said mobile station by respectively broadcasting a paging message that contains an identifier of said mobile station. Said paging message may for instance be sent on a paging channel to which mobile stations listen even during said dormant period. Therein, a base station may belong to one or more groups of base stations, and thus to one or more routing areas, at a time.

According to a further embodiment of the present invention, said base station that received said data packet takes action to page said mobile station by sending at least one paging message to all base stations of at least one of said one or more groups of base stations, said at least one group of base stations contains said base station that received said data packet, and said reception of said at least one paging message at said base stations of said at least one group of base stations triggers said sending of said respective paging messages for said mobile station from each of said base stations of said at least one group of base stations.

Said at least one group of base stations may be associated with a routing area in which said mobile station is assumed to be located, and thus said base station that received said data packet triggers said base stations of said at least one group of base stations to page said mobile stations in their respective cells. Said at least one group of base stations contains said base station that received said data packet, so that the paging of said mobile station is at least performed in the routing area that is associated with said base station that received said data packet. Equally well, also a paging in further routing areas may be advantageous, which may either contain said base station that received said data packet or not. Said base station that received said data packet may either send only one multicast paging message to all base stations of said at least one group of base stations, for instance if all of said base stations are registered in a multicast group, or may send a plurality of unicast paging messages to each of said base station of said at least one group of base stations, respectively.

According to a further embodiment of the present invention, said base station that received said data packet forwards said data packet to all base stations of said at least one group of base stations.

This may for example be accomplished by encapsulating said data packet into said paging message that is sent to said base stations of said at least one group of base stations, or by sending said data packet separately. Said forwarded data packet then may for instance be encapsulated into said paging messages for said mobile station that are sent by said base stations of said at least one group of base stations in their respective cells. Equally well, when said mobile station responds to a paging message send by one base station out of said at least one group of base stations, a traffic channel may be established between said mobile station and said base station, via which traffic channel said data packet then can be transferred to said mobile station. As an alternative to forwarding said data packet to said base stations of said at least one group of base stations, said base station that received said data packet may drop the data packet, and, when the mobile station has been successfully located, said data packet may have to be requested, for instance from a core network of the mobile radio system, by the base station in whose cell said mobile station was located.

According to a further embodiment of the present invention, said base station that received said data packet takes action to page said mobile station by first attempting to page said mobile station in said at least one cell served by said base station, and, if said attempt fails, by sending said at least one paging message to all base stations of said at least one group of base stations.

This attempt to page said mobile station in said at least one cell served by said base station that received said data packet may be based on the assumption that the mobile station has only low mobility, so that it is very likely that said mobile station is located in said at least one cell that is served by said base station. This may be particularly advantageous in a case where said data packet was sent to said base station, because said base station is the one base station out of said plurality of base stations of said mobile radio system in a cell of which base station said mobile station was last known to be located, for instance because the last data transfer of said mobile station was serviced by said base station or because said mobile station last registered with said base station. Directly attempting to page said mobile station in said at least one cell served by said base station significantly reduces the signalling overhead caused by paging in the mobile radio system. Said base station may for instance always attempt to directly page said mobile station in said at least one cell before sending said message to all base stations of said at least one group of base stations, or may decide on its own if it is advantageous to attempt to directly page said mobile station before sending said message to all base stations of said at least one group of base stations. Signalling may be further reduced by demanding that, in case paging was performed without success in said at least one cell served by said base station, said base station does not send said at least one paging message to itself when sending said at least one paging message to all base stations of said at least one group of base stations, or does not repeat paging of said mobile station when receiving said at least one paging message from itself.

According to a further embodiment of the present invention, said base station that received said data packet takes action to page said mobile station by first attempting to give a traffic channel allocation for a transmission of said data packet to said mobile station, and, if said attempt fails, by sending said at least one paging message to all base stations of said at least one group of base stations.

Instead of performing instant paging of said mobile station in said at least one cell served by said base station that received said data packet, when assuming that said mobile station is located in said at least one cell, it may also be advantageous to directly allocate a traffic channel for said mobile station. This allocation may be notified to the mobile station in a broadcast channel or a paging channel, and if said mobile station listens to one of said channels, it may recognize that the base station intends to send said data packet. Directly allocating a traffic channel for said mobile station in said at least one cell served by said base station significantly reduces the signalling overhead caused by paging in the mobile radio system.

According to a further embodiment of the present invention, said base station that receives said data packet takes action to page said mobile station by sending a message to an instance of said mobile radio system to trigger said instance to send at least one paging message to all base stations of at least one of said one or more groups of base stations, said at least one group of base stations contains said base station that received said data packet, and said reception of said at least one paging message at said base stations of said at least one group of base stations triggers said sending of said respective paging messages for said mobile station from each of said base stations of said at least one group of base stations.

Said instance may for example be comprised in one of said base stations of said mobile radio system, or may be implemented otherwise in said mobile radio system. Said at least one group of base stations may for instance be a group of base stations in which said base station that received said data packet is contained. Although the initiation of the paging of the mobile station is still performed by the base station that receives said data packet destined for said mobile station, the triggering of the base stations of the group of base stations that is associated with the routing area in which said mobile station is assumed to be located is delegated to said instance of said mobile radio system. It may then for example be only required that each base station stores the address of said instance, and does not have to store addresses of all base stations of said at least one group of base stations that is associated with said routing area. Upon reception of a paging message from said base station that received said data packet, said instance may then for example determine the address of the base station that sent the paging message, determine to which group of base stations said base station belongs, and then send at least one paging message to all base stations of said determined group of base stations to trigger a paging of said mobile station in the cells of said base stations. If said base station belongs to several groups of base stations at a time, said instance may require additional information to uniquely determine to which group of base stations said base station belongs. Such information may for instance be included in said paging message.

According to a further embodiment of the present invention, said base station that received said data packet forwards said data packet to said instance of said mobile radio system. This may for example be accomplished by encapsulating said data packet into said paging message that is sent to said instance, or by sending said data packet separately.

Said instance then may further forward said data packet, for example to one or all base stations of said at least one group of base stations.

According to a further embodiment of the present invention, said base station that received said data packet takes action to page said mobile station by first attempting to page said mobile station in said at least one cell served by said base station, and, if said attempt fails, by sending said message to said instance of said mobile radio system.

The method according to this embodiment may reduce the signalling overhead required for paging in particular when said mobile station is likely to be located in said at least one cell that is served by said base station that received said data packet. Signalling may be further reduced by demanding that, in case paging was performed without success in said at least one cell served by said base station, said instance of said mobile radio system does not send said at least one paging message to said base station that received said data packet, or that said base station does not repeat paging of said mobile station when receiving said at least one paging message from said instance.

According to a further embodiment of the present invention, said base station that received said data packet takes action to page said mobile station by first attempting to give a traffic channel allocation for a transmission of said data packet to said mobile station, and, if said attempt fails, by sending said message to said instance of said mobile radio system.

The method according to this embodiment may, like the previous embodiment of the present invention, further reduce the signalling overhead required for paging in particular when said mobile station is likely to be located in said at least one cell that is served by said base station that received said data packet.

According to a further embodiment of the present invention, said base station that received said data packet decides on its own if it first attempts to page said mobile station in said at least one cell.

According to a further embodiment of the present invention, said decision of said base station that received said data packet is based on a learning algorithm. This learning algorithm may for instance process experience on in which kind of conditions the direct paging of the mobile station was successful, and may automatically adapt to the environment the base station is embedded in. For instance, fast mobility of the mobile station may be assumed by this algorithm near a highway, and low mobility may be assumed in an office building.

According to a further embodiment of the present invention, at least all base stations of said at least one group of base stations are registered in a multicast group, and said at least one paging message is sent to said base stations of said at least one group of base stations by sending a single multicast paging message to said multicast group by means of a multicast protocol.

Said at least one paging message, which is sent to all base stations in said at least one group of base stations either by said base station that received said data packet or by said instance of said mobile radio system, then is a single multicast message, which is directed to the multicast address of said multicast group. The delivery of said single multicast message to all members of said multicast group then is taken care of by a multicast protocol. In case that said multicast paging message is sent by said base station that received said data packet, all base stations of said mobile radio system only may have to know the multicast address of the one or more multicast groups they are registered in in order to be able to initiate the paging of a mobile station for which a data packet is received. In case that said multicast paging message is sent by said instance of said mobile radio system, in turn said instance, at least for sending said paging message, only has to know the multicast addresses of all of said groups of base stations that are associated with different routing areas of said mobile radio system. However, if said instance detects from which base station said paging message it received was sent and automatically determines to which of said groups of base stations said base station belongs, it may also be required that said instance has at least knowledge of the base stations that are contained in each of said groups of base stations. Membership of base stations in said multicast group may for example be managed by a management protocol, as for instance the Internet Group Management Protocol (IGMP) for IPv4 or the Multicast Listener Discovery (MLD) protocol for IPv6. Group membership may be distributed in the mobile radio system by a multicast routing protocol, as for instance the Protocol-Independent Multicast Sparse Mode (PIM-SM) protocol.

According to a further embodiment of the present invention, said multicast protocol is a network layer multicast protocol. Said network layer is the third layer according to the International Standardization Organisation (ISO) Open Systems Interconnection (OSI) reference model for the communication of open systems.

According to a further embodiment of the present invention, said multicast protocol is an Internet protocol. This may for instance be the IPv4 or the IPv6 protocol or a successor thereof.

According to a further embodiment of the present invention, said multicast protocol is a data link layer multicast protocol. Said data link layer is the second layer of the ISO OSI reference model for the communication of open systems.

According to a further embodiment of the present invention, said multicast protocol is an Ethernet protocol.

According to a further embodiment of the present invention, said multicast protocol is a network layer multicast protocol on top of a data link layer multicast protocol. This may for instance be an Internet protocol on top of an Ethernet protocol.

According to a further embodiment of the present invention, said data link layer multicast protocol at least partially configures multicasting at the data link layer by snooping information from multicasting at the network layer.

For instance, if said network layer protocol is an IPv4 protocol, IGMP may be used to manage membership in said multicast group. Data link layer elements such as for instance Ethernet switches then may perform IGMP snooping by passively examining IP packets transferred between IP multicast routers/switches and IP multicast hosts to learn the IP multicast group membership and to configure the multicasting at the data link layer accordingly. This allows for an efficient mapping of IP multicast groups to data link layer multicast groups.

According to a further embodiment of the present invention, when a mobile station enters said dormant period, a base station, which serves a cell in which said mobile station is located when entering said dormant period, stores information on at least one of said mobile station and an association between said mobile station and a routing area that comprises said cell.

By storing said information, said base station may become an anchoring point for said mobile station during said dormant period of said mobile station, whereas during a non-dormant (active) period of said mobile station, in which said mobile station may have established traffic channels towards a base station, said base station towards which said traffic channels have been established serves as an anchoring point. For each mobile station, the mobile radio system then only may have to keep track of a single base station serving as an anchoring point for said mobile station. If said mobile station has to register with a base station of a new routing area when a border between two routing areas is crossed, the position of said mobile station then may be known at least at routing area precision during said dormant period. In contrast, during said non-dormant mode, the position of said mobile station may be known at cell precision. If said base station, which serves said cell in which said mobile station is located when entering said dormant period, belongs to more than one group of base stations with respectively associated routing areas, said base station may have to store information on which of said routing areas said mobile station is registered in when entering said dormant mode. Said stored information may furthermore be mobile station related context information, for instance encryption related information or information on mobile station policies. Such information may be retrieved by said base station from a previous anchoring point of said mobile station.

According to a further embodiment of the present invention, said plurality of base stations of said mobile radio system comprises at least a first and a second group of base stations with respectively associated first and second routing areas, base stations of said first and second groups of base stations broadcast identifications of said first and second routing areas, respectively, and said mobile station, when noticing based on a reception of said broadcast identifications that it moved from said first to said second routing area, indicates its movement to said second routing area to at least one of said base stations of said second group of base stations. Therein, a base station may belong to both said first and second group of base stations at a time.

This embodiment of the present invention may ensure that the mobile radio system knows at least the routing area said mobile station is located in during said dormant period. The base station to which said movement to said second routing area is indicated may then be considered as a new anchoring point for said mobile station, to which data packets destined for said mobile station can be directed. Said base station may signal that it took over responsibility for the paging of said mobile station to an instance of the mobile radio system.

According to a further embodiment of the present invention, at least one base station of said mobile radio system assigns itself to at least one of said one or more groups of base stations, and said self-assignment is based on information on which group of base stations at least one neighbouring base station of said at least one base station belongs to.

The base station then auto-configures itself by deciding on its own which routing area or areas it belongs to, thus allowing for reduced configuration overhead. Alternatively, said assignment of base stations to groups of base stations may be pre-defined, and then may for instance be queried by the base stations from a central server process in said mobile radio system, or may be configured into said base stations by an operation and maintenance service.

According to a further embodiment of the present invention, said base station that received said data packet registered as an anchoring point for the paging of said mobile station prior to the reception of said data packet, and said registration has the effect that all data packets destined for said mobile station are sent to said base station.

According to a further embodiment of the present invention, a base station that is registered as an anchoring point for the paging of a specific mobile station may trigger an element of said mobile radio system to register as an anchoring point for the paging of said specific mobile station. Said element of said mobile radio system may for instance be another base station of said mobile radio system, for instance a dedicated base station, or a modified base station which may for instance not provide a radio access interface. Said base station may for instance decide that it has become unlikely that a mobile station is still located in the at least one cell served by said base station, and thus may hand over the paging responsibility to said element of said mobile radio network. This decision may for instance be based on an estimated or measured mobility of said mobile station.

It is further proposed a computer program with instructions operable to cause a processor to receive a data packet destined for a mobile station of a mobile radio system at a base station from a plurality of base stations of said mobile radio system during a dormant period of said mobile station, wherein each of said base stations serves at least one cell of said mobile radio system, and wherein it is unknown in which cell of said mobile radio system said mobile station is located during said dormant period; and to take action at said base station that received said data packet to page said mobile station in response to said received data packet in order to determine said cell in which said mobile station is located.

Said computer program may for instance be executed by a processor in said base station.

It is further proposed a computer program product comprising a computer program with instructions operable to cause a processor to receive a data packet destined for a mobile station of a mobile radio system at a base station from a plurality of base stations of said mobile radio system during a dormant period of said mobile station, wherein each of said base stations serves at least one cell of said mobile radio system, and wherein it is unknown in which cell of said mobile radio system said mobile station is located during said dormant period; and to take action at said base station that received said data packet to page said mobile station in response to said received data packet in order to determine said cell in which said mobile station is located.

Said computer program product may for instance be any electric, magnetic or optic storage medium or unit. Said computer program comprised in said computer program product may for instance be executed by a processor in said base station.

It is further proposed a base station in a mobile radio system that comprises a plurality of base stations each serving at least one cell of said mobile radio system, said base station comprising means arranged for receiving a data packet destined for a mobile station during a dormant period of said mobile station, wherein it is unknown in which cell of said mobile radio system said mobile station is located during said dormant period; and means arranged for taking action to page said mobile station in response to said data packet received during said dormant period in order to determine said cell in which said mobile station is located.

It is further proposed a mobile station in a mobile radio system comprising a plurality of base stations each serving at least one cell of said mobile radio system, said mobile station comprising means for entering a dormant period during which it is unknown in which cell of said mobile radio system said mobile station is located; and means arranged for allowing said mobile station to be paged by a base station during said dormant period, wherein said base station takes action to page said mobile station in order to determine said cell in which said mobile station is located in response to a data packet destined for said mobile station and received at said base station during said dormant period.

It is further proposed a mobile radio system, comprising a plurality of base stations each serving at least one cell of said mobile radio system; and a mobile station; wherein said mobile station comprises means for entering a dormant period during which it is unknown in which cell of said mobile radio system said mobile station is located; and wherein said base stations comprise means arranged for receiving a data packet destined for said mobile station during said dormant period of said mobile station, and means arranged for taking action to page said mobile station in order to determine said cell in which said mobile station is located in response to said data packet received during said dormant period.

These and other aspects of the invention will be apparent from and elucidated with reference to the embodiments described hereinafter.

### BRIEF DESCRIPTION OF THE FIGURES

In the figures show:

FIG. 1a: An exemplary embodiment of a mobile radio system according to the present invention;

FIG. 1b: an alternative embodiment of a mobile radio system according to the present invention;

FIG. 2: a schematic representation of the components of an exemplary embodiment of a base station according to the present invention;

FIG. 3a: a flowchart of an exemplary embodiment of a base station process according to the method for paging a mobile station according to the present invention;

FIG. 3b: a flowchart of an exemplary embodiment of a further base station process according to the method for paging a mobile station according to the present invention;

FIG. 3c: a flowchart of an exemplary embodiment of a further base station process according to the method for paging a mobile station according to the present invention;

FIG. 4a: a flowchart of an exemplary embodiment of a mobile station process according to the method for paging a mobile station according to the present invention;

FIG. 4b: a flowchart of an exemplary embodiment of a further mobile station process according to the method for paging a mobile station according to the present invention; and

FIG. 5: a schematic illustration of an area of a mobile radio system being divided into cells and routing areas according to the present invention.

### DETAILED DESCRIPTION OF THE INVENTION

The present invention proposes a de-centralized paging procedure for a mobile radio system that comprises a plurality of base stations each serving at least one cell of said mobile radio system. Paging is performed to locate and alert mobile stations that are in a dormant period in which it is unknown in which cell of said mobile radio system said mobile station is located. Paging may for instance be handled by the base stations of said mobile radio system and may be triggered by the reception of a data packet destined for said mobile station at one of said base stations. In response to said received data packet, said base station then may take action to page said mobile station.

In the following part of this detailed description, the invention will be explained by means of exemplary embodiments. It should be noted that the description of the background of the invention in the opening part of this patent specification may be used to support this detailed description.

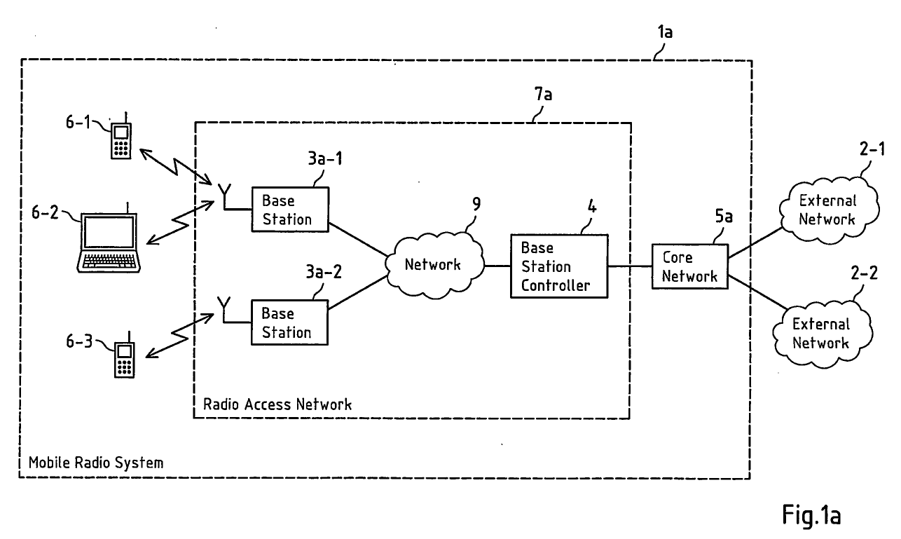

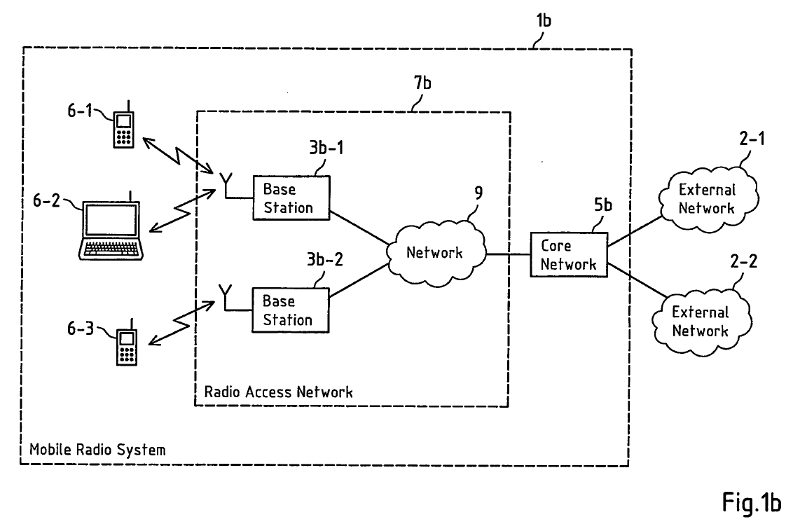

FIG. 1a depicts an exemplary embodiment of a mobile radio system 1a according to the present invention. Said system 1a comprises a core network 5a, a radio access network 7a and a plurality of mobile stations 6-1 . . . 6-3. Furthermore, the core network 5a of said system 1a is connected to two external networks 2-1 and 2-2, which may for instance be a circuit-switched and a packet-switched network, respectively.

The radio access network 7a comprises one or more radio network sub-systems, each comprising a base station controller 4 and one or more base stations 3a-1, 3a-2 connected to said base station controller 4 via a network 9, wherein, for simplicity of presentation, only one radio network sub-system is illustrated. Said network 9 may represent a connection from said base station 3a-1 to said base station controller 4 and a connection from said base station 3a-2 to said base station controller 4. Equally well, said network 9 may represent a type of network in which mutual communication between all of said base station 3a-1, base station 3a-2 and base station controller 4 is possible. Said network 9 may for instance be an Internet Protocol (IP) based network, in which each of said base station 3a-1 and 3a-2 and said base station controller 4 has an IP address via which it can be reached. It may also be possible that base stations 3a-1 and 3a-2 provide interfaces for multiple networks, and/or direct interfaces for mutual communication with each other and/or with further neighbouring base stations.

Base station 3a-1 is assumed to service mobile stations 6-1 and 6-2, and base station 3a-2 is assumed to service mobile station 6-3. The mobile stations 6-1 . . . 6-3 may enter dormant periods to save power and to reduce signaling in the radio access network 7a. To allow for paging of said mobile stations 6-1 . . . 6-3 during dormant periods, said base stations 3a-1 and 3a-2 are assigned to groups of base stations that define routing areas. Therein, a base stations may belong to one or more routing areas at the same time.

The structure of the mobile radio system 1a depicted in FIG. 1a resembles the structure of a prior art mobile radio system. Nevertheless, according to the present invention, paging functionality has been completely moved from said base station controller 4 to said base stations 3a-1 and 3a-2. Instead of said base station controller 4, base stations 3a-1 and 3a-2 are now capable of taking action to page a mobile station in response to a data packet that is received at said base stations 3a-1 or 3a-2 and that is destined for a mobile station that is in a dormant period.

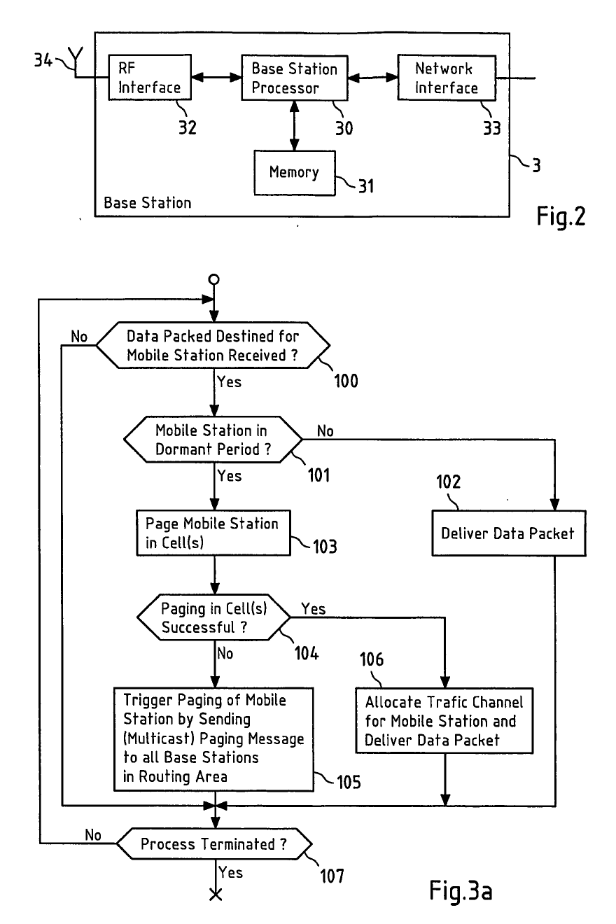

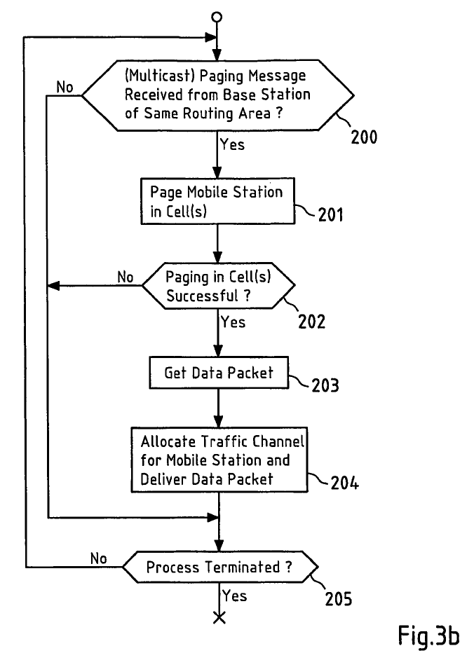

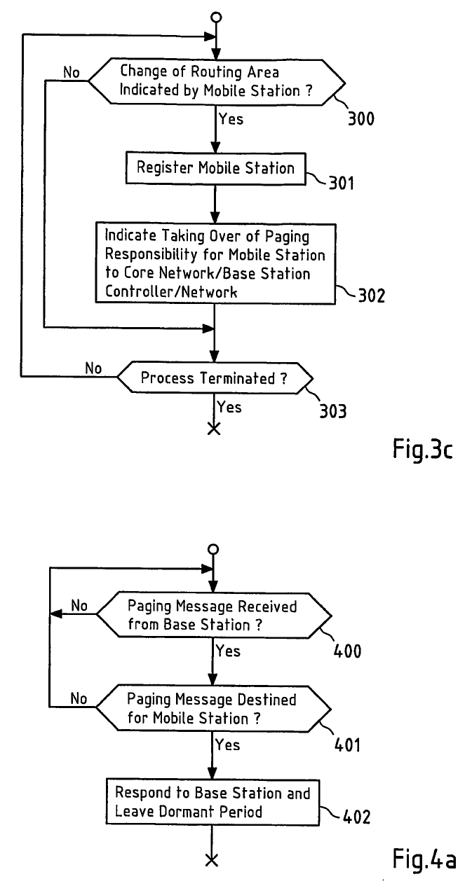

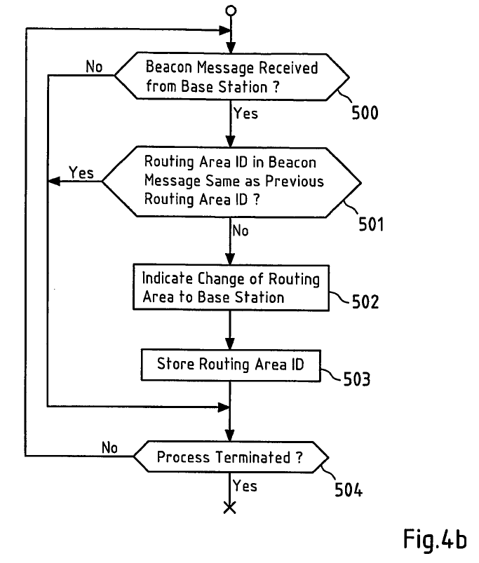

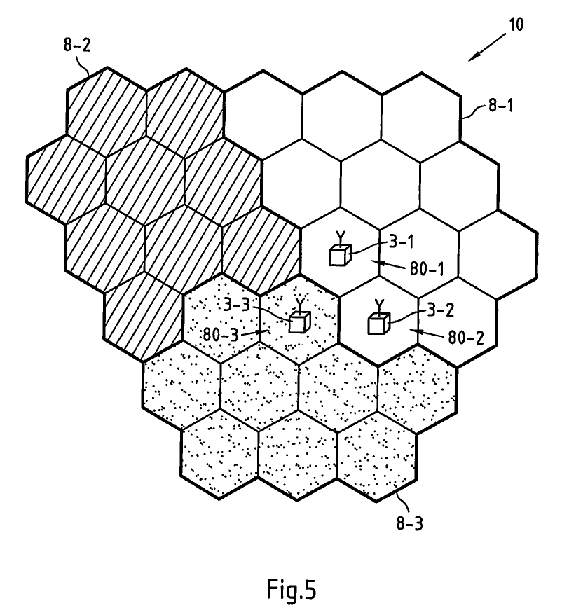

The functional components of the base stations 3a-1 and 3a-2 according to the present invention will be described in more detail with reference to FIG. 2 below. The method steps performed by the base stations 3a-1 and 3a-2 and the mobile stations 6-1 . . . 6-3 to allow for base station initiated paging according to the present invention will be described with reference to the flowcharts of FIGS. 3a-3c and FIGS. 4a-4b below.

FIG. 1b depicts an alternative embodiment of a mobile radio system 1b according to the present invention. Therein, the components of the system 1b that have the same functionality as their counterparts in the system 1a of FIG. 1a are denoted with the same reference numerals. In contrast to the system 1a of FIG. 1a, the system 1b of FIG. 1b comprises a simplified radio access network 7b and an accordingly adapted core network 5b. It is also possible that the core network 5b, compared to the core network 5a of FIG. 1a, remains unchanged. The simplified radio access network 7b comprises only base stations 3b-1 and 3b-2 and a network 9 to which said base stations 3b-1 and 3b-2 are connected, i.e. no more base station controllers (as in FIG. 1a) are present in the radio access network 7b. Said network 9 does not necessarily have to be considered as a part of said radio access network 7b, it may equally well be lumped to the core network 5b or positioned between radio access network 7b and core network 5b. Again, it is readily understood that the illustration of only two base stations 3b-1 and 3b-2 in the radio access network 7b is only of exemplary nature, as, equally well, every other number of base stations in the radio access network 7b is possible. The network 9 at least separately connects the base stations 3b-1 and 3b-2 with the core network 5b. Equally well, said network 9 may additionally allow for a communication between said base stations 3b-1 and 3b-2. Said network element 9 may, similar to the system 1a of FIG. 1a, be an IP based network.

The lack of base station controllers in system 1b is due to the fact that the present invention allows to completely move the paging functionality from base station controllers to base stations 3b-1 and 3b-2. If, as it is assumed for the system 1b of FIG. 1b, additionally the remaining functionality of the base station controller is distributed into the base stations 3b-1 and 3b-2 and/or the core network 5b, the existence of a base station controller in the system 1b becomes dispensable. Data packets can then be directly received by the base stations 3b-1 and 3b-2 from the core network 5b via the network 9, and, if said data packets are destined for mobile stations that are in dormant mode, base stations receiving the data packets will take steps to page said mobile stations to allow for a delivery of the data packets.

FIG. 2 schematically depicts the components of an exemplary embodiment of a base station 3 according to the present invention. Said base station 3 may for instance represent the base stations 3a-1 and 3a-2 of FIG. 1a or the base stations 3b-1 and 3b-2 of FIG. 1b. The core of the base station 3 is formed by the base station processor 30, which controls the functions of the base station 3 and in particular the interfaces of the base station 3 to the mobile stations 6-1 . . . 6-3 (see FIGS. 1a and 1b) on the one hand, and to the network 9 on the other hand.

To this end, the base station processor 30 interacts with a memory 31, which may for instance contain the code for processes that are to be executed by the base station controller 30 (for instance as a computer program on a computer program product). Said memory 31 may further comprise information stored for the sake of paging, as for instance addresses of base stations that belong to the same routing area as base station 3, and/or an address of a multicast group in which all base stations that belong to the same routing area as base station 3 are registered, and/or an address of an instance in said mobile radio system that, upon reception of a paging message, triggers the base stations that belong to the same routing area as base station 3 to send paging messages for a mobile station in their respective cells, and/or a list of mobile stations that are in a dormant mode and last registered with the base station 3, and/or a list of associations between mobile stations that are in dormant mode and the routing area they are registered in, and/or any other type of paging-related information.

Radio Frequency (RF) interface 32 provides for the transformation of base band data that is to be exchanged between base station 3 and one or several mobile stations to RF signals that can be transferred via the air interface between the base station 3 and mobile stations located in one or more cells that are served by said base station 3. Said RF signals are transmitted and received via the one or more antennas 34 of the base station 3, which may for instance be antennas with an omnidirectional or a sectorized radiation pattern. The network interface 33 provides for the interfacing of data and signals that are to be exchanged between the base station processor 30 and the network 9 (see FIGS. 1a and 1b), i.e. with the base station controller 4 of FIG. 1a, the core network 5b of FIG. 1b, and possibly other base stations (e.g. base station 3a-1 or 3a-2 of FIGS. 1a and 1b).

When data packets destined for a mobile station are received via network interface 33 of the base station 3, the base station processor 30 may for instance follow the steps of the process illustrated by the flowchart of FIG. 3a in order to page said mobile station and/or to deliver said data packet.

According to the first step 100 of the base station process illustrated by the flowchart of FIG. 3a, the base station processor 30 (see FIG. 2) checks if a data packet destined for a mobile station was received via the network interface 33 (see FIG. 2). If this is the case, the base station processor 30 checks whether the mobile station said received data packet is destined for is in dormant mode. This may for instance be performed by checking a list of mobile stations that are in dormant mode stored in said memory 31 of base station 3 (see FIG. 2), or by checking if said base station has traffic channels established to said mobile station (in which said mobile station would be in non-dormant mode).

If it is decided that said mobile station is not in a dormant period, said base station delivers said data packet to said base station in a step 102, for instance by using a traffic channel that may already be established between said base station 3 and said mobile station.

Otherwise, said base station 3 may attempt in step 103 to page said mobile station in the at least one cell that is served by said base station 3. This step is based on the assumption that, particularly in case of low mobility of the mobile station, the probability of the mobile station not having left the cell that is served by base station 3 is high, as will be explained in more detail with reference to the flowchart of FIG. 3c below. This paging may for instance be performed by base station 3 by broadcasting a paging message to all mobile stations located in its at least one cell. To this end, the base station processor 30 (see FIG. 2) may format an according paging message, which may then be converted to an RF signal by means of the RF interface 32 and then may be transmitted by antenna(s) 34 of the base station. As an alternative to said cell-level paging performed in step 103, said base station 3 may also directly allocate a traffic channel to said mobile station and attempt to directly deliver said data packet. It should however be noted that both the cell-level based paging performed in step 103 and the direct allocation of a traffic channel for the mobile station are optional. In the flowchart of the base station process depicted in FIG. 3a, if it is determined in step 101 that the mobile station the received data packet is destined for is in dormant mode, instead of steps 103 and 104, directly step 105 may be performed, and then also step 106 would be dispensable. Base station 3 may also decide on its own if it is advantageous to perform steps 103, 104 and 106. This decision may for instance be based on a learning algorithm, which processes experience on in which kind of conditions the direct paging of the mobile station (cf. step 103) was successful, and which automatically adapts to the environment base station 3 is embedded in. For instance, fast mobility of the mobile station may be assumed near a highway, and low mobility may be assumed in an office building, and then steps 103, 104 and 106 may only be performed in the office building scenario. The process performed at a mobile station in response to the reception of the paging message sent by the base station in step 103 of the flowchart of FIG. 3a is depicted in FIG. 4a. Therein, it is first checked in a step 400 if a paging message was received from a base station. If this is the case, it is determined if the paging message is directed to the mobile station that executes the process, or to another mobile station. In the former case, a response is sent to the base station that sent the paging message, and the dormant period is left. This terminates the process. In the latter case, and also in case that the paging message is destined for another mobile station (see step 401), the process loops back to step 400.

Returning to the base station process depicted in FIG. 3a, in step 104, it is checked if this paging of the mobile station in the at least one cell served by base station 3 was successful, for instance by checking if a response was received from the mobile station. In this case, the mobile station is known to be located in the at least one cell served by base station 3, and the base station can then proceed to step 106, allocate a traffic channel for the mobile station and deliver said data packet to said mobile station via said traffic channel. If more than one cell is served by base station 3, and if different orthogonal or pseudo-orthogonal transmission resources are used in these cells, base station 3 may be capable of determining in which of its cells the mobile station is located, for instance based on the transmission resource used by the mobile station in its response to base station 3.

If paging in the at least one cell served by the base station was not successful, paging on a routing-area-level has to be performed in step 105. To this end, the base station 3 that received the data packet destined for the mobile station sends at least one paging message to all base stations of a group of base stations, wherein all base stations of said group of base stations are in the same routing area as base station 3 that received the data packet, and wherein said routing area is assumed to house said mobile station. More details on the formation of routing areas according to the present invention will be discussed with reference to FIG. 5 below. Said at least one paging message contains at least an identification of said mobile station for which said data packet is destined. A plurality of single-cast paging messages may be sent by base station 3 to all base stations of said group of base stations (but optionally not to itself again), respectively, or only one multicast paging message may be sent to a multicast group in which all base stations of said group of base stations are registered. Said at least one paging message is sent to said base stations via network interface 33 of base station 3 (see FIG. 3). For instance, if said network 9 (see FIGS. 1a and 1b) is an IP based network, said at least one paging message may be sent to the other base stations as IP packets that are destined to the IP addresses of said base stations. If only a single multicast paging message is sent to said base stations, said base station may be registered in an IP multicast group, and said single multicast paging message may then be sent as single IP packet to the IP address of said multicast group.

In said step 105, said data packet may optionally be encapsulated into or attached to said at least one paging message that is sent to said base stations in order to forward said data packet to said base stations.

As an alternative to step 105, the base station 3 may also send said paging message to an instance in said mobile radio system 1a or 1b (see FIGS. 1a and 1b), and then said instance may send at least one paging message to said base stations of said group of base stations in order to trigger said base stations to page the mobile station in their respective cells. If said at least one paging message is a multicast message, and if said base stations of said group of base stations are registered in a multicast group to which said multicast message is sent, said instance may then for instance deploy Source Specific Multicast (SSM), enabling more efficient multicast group address management and routing.

Said sending of said at least one paging message to all base stations of the routing area triggers a paging of the mobile station in the cells of all of said base stations, or, in other words, in the routing area that base station 3 belongs to and that is assumed to house said mobile station. Details on the actions taken by a base station in response to the reception of a paging message from another base station of the same routing area are described below with reference to the flowchart of FIG. 3b.

After the sending of the paging message to all base stations of the routing area that contains base station 3 and that is assumed to house the mobile station, at least with respect to paging of said mobile station, no further tasks are required from base station 3. The process thus checks in a step 107, if termination of the process is desired. If this is the case, the process is terminated. Otherwise, the process loops back to step 100 and awaits the reception of new data packets. Step 107 is also performed if it is determined in step 100 that no data packet was received, and after steps 102 and 106.

FIG. 3b depicts the steps of a process performed by a base station 3 (see FIG. 2) according to the present invention in response to the reception of said at least one paging message (sent in step 105 of the flowchart of FIG. 3a) from another base station of the same routing area.

If it is detected in a step 200 that a paging message (either as a single-cast or multicast paging message, and either sent from said base station that received said data packet destined for said mobile station or from said instance of said mobile radio system) was received via the network interface 33 (see FIG. 2), a paging is triggered in the at least one cell that is served by base station 3 that received the paging message. The base station 3 thus determines from the received paging message (for instance by extracting a mobile station identifier from said received paging message) which mobile station is to be paged, and sends an according paging message destined for said mobile station to all mobile stations in its at least one cell, for instance via its RF interface 32 and antenna(s) 34 (see FIG. 2). The process performed at the mobile stations upon reception of this paging message was already described with reference to FIG. 4a above. Optionally, said base station 3 may check if said paging message originates from itself, because said base station 3 was the base station that sent said paging message to said group of base stations in step 105 of the flowchart of FIG. 3a. In this case, paging has already been performed without success (cf. steps 103 and 104 of the flowchart of FIG. 3a), and may not have to be repeated again to reduce signalling overhead and interference caused in neighbouring cells.

After the sending of this paging message, it is checked in a step 202 in the flowchart of FIG. 3b if said cell-based paging was successful, i.e. if a mobile station located in the at least one cell of the base station responded to the paging message. If this is the case, the base station 3 gets the data packet that is destined for said mobile station in a step 203. This data packet may for instance have been encapsulated or attached to the paging message that was sent to the base station 3 that received the paging message from the base station that originally received the data packet, or may be requested anew, for instance from the base station that originally received the data packet, or the base station controller 4 (see FIG. 1a), or the core network 5b (see FIG. 1b) via the network 9.

As soon as the data packet is available at the base station 3 that received the paging message, a traffic channel is allocated for the mobile station, and the data packet is delivered to the mobile station via this traffic channel.

After the delivery of the data packet in step 204, and also in case that no paging message was received at all (see step 200) and in case that paging in the at least one cell was not successful (see step 202), it is determined in step 205 if the actual process shall be terminated or not. If this is not the case, the process loops back to step 200, and otherwise, the process is terminated.

FIG. 3c is a flowchart of an exemplary embodiment of a further base station process according to the method for paging a mobile station according to the present invention. This process may for instance be performed at a base station 3 (see FIG. 2) according to the present invention in parallel to the processes of FIGS. 3a and 3b. In a step 300, it is checked if a change of the routing area is indicated by a mobile station. Such an indication is performed by a mobile station if it determines that it moved from one routing area to another routing area during a dormant period, as will be explained with reference to FIG. 4b below.

If it is determined in step 300 that a change in the routing area was indicated by a mobile station, for instance in the form of a message received via the antenna(s) 34 and RF interface 32 of base station 3 (see FIG. 2), the base station 3 registers said mobile station by storing information on said mobile station and/or on an association between said mobile station and the new routing area in a step 301. For instance, if said base station 3 that receives said indication of a change of the routing area belongs only to one routing area, only an identifier of said mobile station may be stored, for instance in a list of mobile stations that is maintained in memory 31 of base station 3 (see FIG. 2). Said list then contains all mobile stations which are in a dormant period and for the paging of which said base station 3 has become an anchoring point. The only way to page said mobile stations on said list may then be to send a data packet destined for said mobile stations to said base station 3 (via the network 9 in FIGS. 1a and 1b). Upon reception of such data packets, the base station 3 then performs the process of the flowchart of FIG. 3a and takes action to page the corresponding mobile station. If said base station 3 belongs to more than one routing area, information on an association between said mobile station and one specific routing area may have to be stored by said base station 3.

When registering the mobile station that indicates the change of the routing area at base station 3, which thus becomes the new anchoring point for this mobile station, furthermore relevant context information, such as encryption related keys or mobile station related policies, may be transferred from the previous anchoring point to the new anchoring point. This may for instance be triggered by the new anchoring point (base station 3) by requesting this information from the previous anchoring point, for instance via the network 9 (see FIGS. 1a and 1b).

In step 302, said base station 3 updates the base station controller 4 and/or the core network 5a of the system 1a (see FIG. 1a), the core network 5b of the system 1b (see FIG. 1b) or an instance in the network 9 (see FIGS. 1a and 1b) with information on the mobile stations that are, at least with respect to paging, under the control of the base station 3. A similar list of mobile stations may be maintained and a similar updating may be performed for the mobile stations that are not in dormant mode and that are associated with said base station 3 (for instance by having established traffic channels with said base station 3), so that it is always clear how a mobile station can be reached in the mobile radio system 1a or 1b (see FIGS. 1a and 1b).

After step 302, and also if the check in step 300 reveals that no change of a routing area is indicated by a mobile station, it is checked in step 303 if the process shall be terminated. If this is the case, the process is terminated, and otherwise, the process loops back to step 300.

Base station 3 may optionally run a further process that determines that it is highly unlikely that the mobile station is still reachable in its at least one cell, for instance based on interaction with the learning algorithm that was already mentioned in the context of steps 103, 104 and 106 in the flowchart of FIG. 3a. For instance, it may be determined that, due to high mobility of the mobile station, the mobile station will have left the at least one cell served by base station 3 after a certain time period that starts when it is determined in step 300 that the change of the routing area is indicated by the mobile station, and that may be controlled by setting a timer. Base station 3 then may load off the paging responsibility for the mobile station to a special node in the infrastructure, which special node is capable of functioning as a new anchoring point for the mobile station and may be able to take care of the paging process similar to base station 3. This may save RAN resources, as the data packet causing the paging procedure in the RAN will not have to be sent to the (possibly busy) base station 3 in vain. This special node may for instance be one dedicated base station of said base stations 3a-1 and 3a-2 (see FIGS. 1a and 1b), or may be a special type of base station, for instance without a radio access interface. Said special node may be located anywhere in the RAN, in particular it may not be located on the path between the core network and the previous anchoring point.

FIG. 4b depicts a flowchart of an exemplary mobile station process that may be performed by a mobile station according to the present invention in parallel to the process of FIG. 4a in order to inform the mobile radio system 1a or 1b (see FIGS. 1a and 1b) on the routing area said mobile station presently is located in.

To this end, it is checked in a step 500 if a beacon message from a base station is received. Said beacon messages are regularly broadcast by all base stations of said mobile radio system and contain identifiers (IDs) of the routing areas the broadcasting base stations belong to. If a base station belongs to several routing areas, IDs of each of said routing areas may be contained in said beacon messages. Then the sequence in which said IDs are contained in said beacon message may indicate to a mobile station which of said routing areas it should preferably join in case that the ID of the current routing area of the mobile station is not listed in said beacon message; for instance the routing area the ID of which is the first one in said beacon message should be preferably joined by said mobile station. The base station then may control the selection of routing areas by the mobile station by accordingly changing the sequence of said IDs. If a beacon message is received by the mobile station, it is checked in a step 501 if the ID of the routing area the mobile station currently belongs to is listed in the received beacon message. If this is not the case, the mobile station has obviously crossed a border between two routing areas, and this has to be signalled to the base station that broadcast the received beacon message and that belongs to the new routing area. This signalling is performed in step 502, and triggers the steps of the flowchart of FIG. 3c at the base station as explained above. Furthermore, in a step 503, the new routing area ID is stored for comparison purposes with future received routing area IDs. Finally, it is determined if the process shall be terminated or not in step 504. If termination is desired (for instance due to the mobile station leaving the dormant mode), the process is terminated, and otherwise, the process loops back to step 500. Step 504 is also performed if it is determined in step 500 that no beacon message was received and if it is determined in step 501 that the routing area has not changed.

FIG. 5 depicts a portion 10 of the coverage area of a mobile radio system 1a or 1b (see FIGS. 1a and 1b) according to the present invention. The coverage area is paved with (exemplarily) hexagonal cells, wherein only cells 80-1, 80-2 and 80-3 are furnished with reference numerals. In this example, each of said cells is served by a base station 3-1 . . . 3-3, respectively, wherein the cells represent the approximate area for which each base station 3-1 . . . 3-3 can provide radio coverage. As already mentioned, it is also possible that a base station serves more than one cell, for instance if sectorized antennas or adaptive antennas are used. The cells depicted in FIG. 5 form three routing areas 8-1, 8-2 and 8-3. The base stations that serve the cells of one routing area then are understood to form a group of base stations, and the routing area then is associated with said group of base stations. It is then also common to say that a base station belongs to a routing area. It should be noted that a base station can well belong to more than one group of base stations and thus to more than one routing area at a time. For simplicity of presentation, this case is not considered in FIG. 5.

During a dormant period of a mobile station, as the mobile station only reports changes of the routing area it is located in (and not the cell), the location of the mobile station is only known at routing-area precision. In contrast, in a non-dormant period, for instance when the mobile station has a traffic channel established with a base station, the location of the mobile station may be known at cell precision.

The base stations may be assigned to the groups of base stations that are associated with respective routing areas 8-1 . . . 8-3 by an operator of said mobile radio system or may perform an automatic assignment by themselves, for instance by determining to which routing areas one or more close neighbour base stations belong (this can for instance be accomplished by mutual communication between the base station 3a-1 and 3a-2 or 3b-1 and 3b-2 via the network 9 of FIGS. 1a and 1b). In the former case, the base stations may query information on the group of base stations they belong to during or after the commissioning of the base stations, or may be configured with respect to the group of base stations by an operation & maintenance procedure of the mobile radio system.

To reduce signalling overhead in the radio access network 7a or 7b of the mobile radio system 1a or 1b according to the present invention (see FIGS. 1a and 1b), it is advantageous to register all base stations of a group of base stations that is associated with a respective routing area in a multicast group. Said at least one paging message, which is sent from a base station that takes action to page a mobile station to all base stations of said group of base stations or from said instance of said mobile radio system (see step 105 of FIG. 3a) via the network 9 of FIGS. 1a and 1b, then is delivered as a single multicast message, i.e. the message contains only the multicast address of the group, and a multicasting protocol takes care of the delivery of said paging message to all base stations registered in said multicast group. The base stations of the mobile radio system then do not require knowledge of the other base stations of the same routing area, the multicast address of the routing area is sufficient. If said base station that takes action to page said mobile station sends a paging message to said instance of said mobile radio system (see step 105 of FIG. 3a), said base station only has to know the address of said instance of said mobile radio system, and said instance then performs the sending of said single multicast paging message to the base stations registered in the same multicast group like the base station that sent the paging message to said instance.

Multicasting may be performed on the network layer, for instance by an Internet Protocol (IP), and/or on a data link layer, for instance by an Ethernet protocol. Correspondingly, in the former case, the multicast message would be an IP packet with the address of the multicast group as destination address, and in the latter case, the multicast message would be an Ethernet packet with the address of the multicast group as destination address.

For each multicast group, a multicast address is assigned. It may be advantageous that a specific multicast group address range is utilized, where the identifier of the group of base stations associated with a respective routing area is directly embedded into the multicast group address to simplify mapping.

If multicasting is performed by the IPv4, the Internet Group Management Protocol (IGMP) may be used to manage multicast groups. In case of IPv6, the Multicast Listener Discovery (MLD) protocol may be applied for the purpose of group management. A multicast routing protocol (e.g. the Protocol-Independent Multicast Sparse Mode (PIM-SM)) may be utilized to distribute the group membership information in the network 9 to which the base stations are connected (see FIGS. 1a and 1b). Additionally, data link layer elements (e.g. Ethernet switches) may participate into the multicast group management, in order to enable efficient mapping between IP multicast groups and data link layer multicast groups (for instance by performing IGMP snooping).

Returning to FIG. 5, finally an exemplary example of a paging of a mobile station in a mobile radio system according to the present invention shall be given. To this end, it is assumed that a mobile station (not shown in FIG. 5) is first registered with base station 3-1 in cell 80-1 of routing area 8-1, wherein said registration of said mobile station may be understood as said mobile station being in non-dormant mode and having a traffic channel established with said base station 3-1.

The mobile station then enters a dormant period and moves to cell 80-2, which is also in routing area 8-1.

A data packet destined for the mobile station is then received at base station 8-1 (because the mobile station was last registered there). In response to the received data packet, the base station 8-1 takes action to page the mobile station, and first attempts to page the mobile station in its own cell 80-1. As the mobile station is already in cell 80-2, this paging fails, and the base station 80-1 then may for instance send a multicast paging message to an IP multicast group in which all base stations of routing area 8-1 are contained. In this IP multicast message, the data packet is encapsulated. The IP multicast paging message is then send to all base stations of said multicast group via the network 9 (see FIG. 1a or 1b). In response to the reception of the multicast paging message sent from base station 3-1, base station 3-2 sends a paging message to all mobile stations in its cell 80-2. The mobile station, which is located in cell 80-2, notices that it is paged by base station 3-2 and responds to base station 3-2. Then a traffic channel can be allocated by base station 3-2 to the mobile station and the data packet, forwarded to base station 3-2 in the multicast paging message, can be delivered to the mobile station. In this way, the mobile station now registered with base station 3-2, and cell-level mobility management is performed for the mobile station, as it is no longer in dormant mode, i.e. the location of the mobile station now is always known at the precision of a cell.

The mobile station then enters a dormant mode again and moves to cell 80-3 that is served by base station 3-3 which in turn belongs to routing area 8-3. When moving to routing area 8-3, the mobile station notices from the beacon message broadcast by base station 3-3 that it moved from routing area 8-1 to routing area 8-3 and signals this change of the routing area to base station 3-3, which then becomes a new anchoring point for the paging of this mobile station.

The invention has been described above by means of exemplary embodiments. It should be noted that there are alternative ways and variations which are obvious to a skilled person in the art and can be implemented without deviating from the scope and spirit of the appended claims. In particular, the present invention is not limited to deployment in mobile communications systems only, it may equally well be used in wireless local area networks and paging systems, for instance the European Radio Messaging System (ERMES). In the latter case, the present invention then may for instance contribute to dispense with or reduce the complexity of a routing area controller that controls a plurality of base stations in such paging systems.

1. A method for paging a mobile station in a mobile radio system that comprises a plurality of base stations each serving at least one cell of said mobile radio system, said method comprising:
receiving a data packet destined for said mobile station at one of said base stations during a dormant period of said mobile station, wherein it is unknown in which cell of said mobile radio system said mobile station is located during said dormant period; and
taking action at said base station that received said data packet to page said mobile station in response to said received data packet in order to determine said cell in which said mobile station is located.

2. The method according to claim 1, wherein said plurality of base stations comprises one or more groups of base stations, wherein each of said groups of base stations is associated with a respective routing area in a way that said cells served by said base stations of a group of base stations form said respective routing area, and wherein said paging of said mobile station comprises sending respective paging messages for said mobile station from each of said base stations of at least one of said one or more groups of base stations.

3. The method according to claim 2, wherein said base station that received said data packet takes action to page said mobile station by sending at least one paging message to all base stations of at least one of said one or more groups of base stations, wherein said at least one group of base stations contains said base station that received said data packet, and wherein said reception of said at least one paging message at said base stations of said at least one group of base stations triggers said sending of said respective paging messages for said mobile station from each of said base stations of said at least one group of base stations.

4. The method according to claim 3, wherein said base station that received said data packet forwards said data packet to all base stations of said at least one group of base stations.

5. The method according to claim 3, wherein said base station that received said data packet takes action to page said mobile station by first attempting to page said mobile station in said at least one cell served by said base station, and, if said attempt fails, by sending said at least one paging message to all base stations of said at least one group of base stations.

6. The method according to claim 3, wherein said base station that received said data packet takes action to page said mobile station by first attempting to give a traffic channel allocation for a transmission of said data packet to said mobile station, and, if said attempt fails, by sending said at least one paging message to all base stations of said at least one group of base stations.

7. The method according to claim 2, wherein said base station that received said data packet takes action to page said mobile station by sending a message to an instance of said mobile radio system to trigger said instance to send at least one paging message to all base stations of at least one of said one or more groups of base stations, wherein said at least one group of base stations contains said base station that received said data packet, and wherein said reception of said at least one paging message at said base stations of said at least one group of base stations triggers said sending of said respective paging messages for said mobile station from each of said base stations of said at least one group of base stations.

8. The method according to claim 7, wherein said base station that received said data packet forwards said data packet to said instance of said mobile radio system.

9. The method according to claim 7, wherein said base station that received said data packet takes action to page said mobile station by first attempting to page said mobile station in said at least one cell served by said base station, and, if said attempt fails, by sending said message to said instance of said mobile radio system.

10. The method according to claim 7, wherein said base station that received said data packet takes action to page said mobile station by first attempting to give a traffic channel allocation for a transmission of said data packet to said mobile station, and, if said attempt fails, by sending said message to said instance of said mobile radio system.

11. The method according to claim 5, wherein said base station that received said data packet decides on its own if it first attempts to page said mobile station in said at least one cell.

12. The method according to claim 11, wherein said decision of said base station that received said data packet is based on a learning algorithm.

13. The method according to claim 3, wherein at least all base stations of said at least one group of base stations are registered in a multicast group, and wherein said at least one paging message is sent to said base stations of said at least one group of base stations by sending a single multicast paging message to said multicast group by means of a multicast protocol.

14. The method according to claim 13, wherein said multicast protocol is a network layer multicast protocol.

15. The method according to any claim 13, wherein said multicast protocol is an internet protocol.

16. The method according to claim 13, wherein said multicast protocol is a data link layer multicast protocol.

17. The method according to claim 13, wherein said multicast protocol is an Ethernet protocol.

18. The method according to claim 13, wherein said multicast protocol is a network layer multicast protocol on top of a data link layer multicast protocol.

19. The method according to claim 18, wherein said data link layer multicast protocol at least partially configures multicasting at the data link layer by snooping information from multicasting at the network layer.

20. The method according to claim 2, wherein, when a mobile station enters said dormant period, a base station which serves a cell in which said mobile station is located when entering said dormant period, stores information on at least one of said mobile station and an association between said mobile station and a routing area that comprises said cell.

21. The method according to claim 2, wherein said plurality of base stations of said mobile radio system comprises at least a first and a second group of base stations with respectively associated first and second routing areas, wherein base stations of said first and second groups of base stations broadcast identifications of said first and second routing areas, respectively, and wherein said mobile station, when noticing based on a reception of said broadcast identifications that it moved from said first to said second routing area, indicates its movement to said second routing area to at least one of said base stations of said second group of base stations.

22. The method according to claim 2, wherein at least one base station of said mobile radio system assigns itself to at least one of said one or more groups of base stations, and wherein said self-assignment is based on information on which group of base stations at least one neighboring base station of said at least one base station belongs to.

23. The method according to claim 1, wherein said base station that received said data packet registered as an anchoring point for the paging of said mobile station prior to the reception of said data packet, and wherein said registration has the effect that all data packets destined for said mobile station are sent to said base station.

24. The method according to claim 1, wherein a base station that is registered as an anchoring point for the paging of a specific mobile station may trigger an element of said mobile radio system to register as an anchoring point for the paging of said specific mobile station.

25. A computer readable medium having a program stored thereon with instructions operable to cause a processor:
to receive a data packet destined for a mobile station of a mobile radio system at a base station from a plurality of base stations of said mobile radio system during a dormant period of said mobile station, wherein each of said base stations serves at least one cell of said mobile radio system, and wherein it is unknown in which cell of said mobile radio system said mobile station is located during said dormant period; and
to take action at said base station that received said data packet to page said mobile station in response to said received data packet in order to determine said cell in which said mobile station is located.

26. (canceled)

27. A base station in a mobile radio system that comprises a plurality of base stations each serving at least one cell of said mobile radio system, said base station comprising:
means arranged for receiving a data packet destined for a mobile station during a dormant period of said mobile station, wherein it is unknown in which cell of said mobile radio system said mobile station is located during said dormant period; and
means arranged for taking action to page said mobile station in response to said data packet received during said dormant period in order to determine said cell in which said mobile station is located.

28. A mobile station in a mobile radio system comprising a plurality of base stations each serving at least one cell of said mobile radio system, said mobile station comprising:
means for entering a dormant period during which it is unknown in which cell of said mobile radio system said mobile station is located;
means arranged for allowing said mobile station to be paged by a base station during said dormant period, wherein said base station takes action to page said mobile station in order to determine said cell in which said mobile station is located in response to a data packet destined for said mobile station and received at said base station during said dormant period.

29. A mobile radio system, comprising:
a plurality of base stations each serving at least one cell of said mobile radio system; and
a mobile station wherein said mobile station comprises:
means for entering a dormant period during which it is unknown in which cell of said mobile radio system said mobile station is located; and wherein said base stations comprise:
means arranged for receiving a data packet destined for said mobile station during said dormant period of said mobile station, and
means arranged for taking action to page said mobile station in order to determine said cell in which said mobile station is located in response to said data packet received during said dormant period.
